(19) United States
(12) Patent Application Publication
(10) Pub. No.: US 2008/0154532 A1
(43) Pub. Date: Jun. 26, 2008

(54) Versatile method and device for monitoring and controlling a test bench

(75) Inventor: Daniel Huillet, Laye (FR)

Correspondence Address: YOUNG & THOMPSON, 209 Madison Street, Suite 500, ALEXANDRIA, VA, 22314, US

(73) Assignee: EUROCOPTER, Marignane Cedex (FR)

(21) Appl. No.: 12/003,107

(22) Filed: Dec. 20, 2007

(30) Foreign Application Priority Data
Dec. 20, 2006 (FR) 06 11133

(51) Int. Cl. G06F 19/00

(52) U.S. Cl. 702/122; 702/85

(57) ABSTRACT

A method and a device (1) for monitoring and controlling a test bench (2) provided with control elements (3) for controlling the bench (2) and with an interface (4) including display elements (41) and also communication elements (42), the control elements (3) being suitable for controlling the test bench (2) The device (1) is also provided with a set (6) of members for determining the configuration of the test and with at least one acquisition input (3′) for acquiring at least one test result measured by at least one acquisition element of the test bench (2)

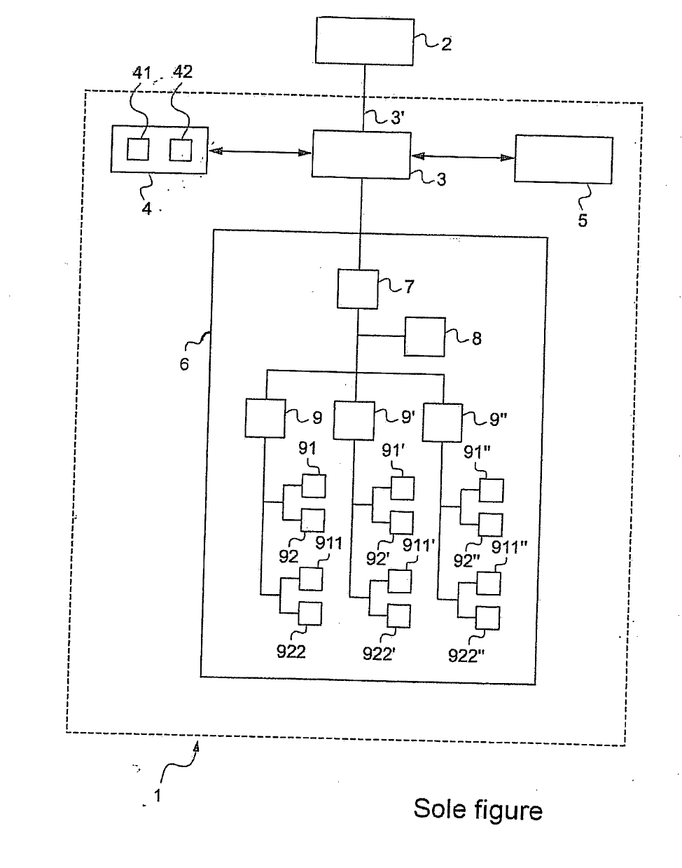

The present invention relates to a versatile method and device for monitoring and controlling a test bench.

### BACKGROUND OF THE INVENTION

Test benches are used, in particular in the field of aviation, but also in all types of industry, for performing development tests that serve to ensure that the equipment under test complies with technical requirements. For example, endurance tests are performed in order to determine the lifetime of a particular type of equipment.

Furthermore, test benches are also used during so-called reception testing for the purpose of verifying, prior to delivery, that equipment is operating correctly.

At present, each test bench is managed by a monitoring device provided with control means and an interface including display means and communication means, e.g. respectively a computer having a microprocessor that communicates with a user via an interface provided with a screen and a keyboard.

Each control means is then dedicated to a particular test bench. It has its own configuration and its own mode of operation. To return to the above example, the microprocessor is programmed to be specific to the bench it controls.

The way the control means are used and/or configured to execute a test on a dedicated bench thus differs from one bench to another. Any one control means is thus suitable solely for performing one specific test on one precise type of equipment, in compliance with its configuration.

For example, the publication by Jean-Frangois Peyrucat: “Solutions reportage—acquisition de données—la supervision intègre tous les standards du banc d'essai” [Reporting solutions—data acquisition—supervision incorporates all test bench standards], published by Measures, Groupe Tests, Paris, France, No. 733, March 2001 (2001-03), pp. 82-85, or indeed U.S. Pat. Nos. 6,381,552 and 6,401,220 describe software including all of the information needed for controlling the bench.

It will readily be understood that such control means present drawbacks for a business possessing a plurality of test benches, with each test bench being suitable for performing a plurality of different tests.

A first drawback is associated with the cost of developing each combination of control means and test bench. It is necessary to carry out new development for each control means, thus leading to high costs for a business that possesses a plurality of test benches.

A second drawback lies in the lack of flexibility of current organization. Because of its specificity, it is not possible to replace the control means of one bench by the control means of another bench in the event of a breakdown. For example, if the computer implementing the microprocessor acting as the control means should break down, it is not possible to replace it by another computer from another bench, insofar as each control means is specific to the test bench it monitors.

Finally, it should be observed that present control means are difficult to reconfigure. If the configuration of the test changes, as a result of a change in the equipment or the systems for testing, it is difficult to adapt the control means to the new configuration because of the initial specificity of the control means.

### OBJECTS AND SUMMARY OF THE INVENTION

An object of the present invention is to provide a versatile method and device for monitoring and controlling a test bench, the device and the method enabling each control means to control a plurality of different test benches.

According to the invention, a device for monitoring and controlling a test bench is provided with control means for controlling the bench and an interface that includes display means and communication means, the control means being suitable for controlling the test bench. The invention is remarkable in that the device is provided with a set of means comprising:
selector means, operated by the control means, to enable the operator to choose the type of test to be implemented; and
at least one election means, operated by the control means, for enabling an operator to choose the article to be tested.

Furthermore, the device is provided with at least one acquisition input for receiving at least one test result measured by at least one acquisition means of the test bench.

Thus, the device is provided with control means capable of monitoring the operation of a plurality of different test benches with the help of the set of means, said set of means being distinct from the control means. In order to adapt to a given situation, the operator chooses the type of test and the article to be tested on the bench to which the operator is attending.

It is thus possible to have a device arranged on each bench, each device being fitted with control means. The devices are interchangeable from one test bench to another since they call on identical sets of means that contain the test configurations, the control means possibly differing from one test bench to another. The above-mentioned drawbacks are thus solved by the invention.

It should be observed that there are preferably as many election means as there are types of test, a given election means being implemented when a specific test is chosen by the operator.

In addition, in a variant of the invention, the set of means of the device includes calibration means, operated by the control means, for resetting the result delivered to the control means by the acquisition means. It is entirely likely that the acquisition means on a test bench become less accurate as a result of aging and thus that measurements need to be reset, for example because they are biased by one degree Celsius if they relate to a temperature measurement.

As a safety precaution, the set of means of the device advantageously includes identification means operated by the control means to verify that the operator is entitled to perform said test. The control means then verify whether the operator is indeed authorized to operate the test bench in question in order to avoid any safety problems. Identification can be implemented with the help of passwords, fingerprints, or indeed encoded cards, for example.

In order to obtain a wider comfort margin, the set of means of the device includes at least one adjustment means operated by the control means to define test conditions, an adjustment means corresponding to a specific article and test. The number of adjustment means is then equal to the sum of all of the tests that can be carried out on all of the articles for testing provided.

The adjustment means are advantageously a database containing the conditions for the chosen test for the elected equipment, i.e. the data needed to carry out the test correctly, comprising for example:
detailed steps of the test;
values for test settings such as bench temperature or vibration level; and
parameters that are monitored and valid values therefor.

Furthermore, in an ergonomic variant of the invention, the set of means of the device includes at least one output means operated by the control means for formatting the presentation of the result.

The output means can format the result for outputting in the form of tables or curves, for example, depending on requirements.

Furthermore, and advantageously, the output means formats the presentation in real time during the test. The operator can thus observe how the test is progressing.

It will readily be understood that there are as many output means as there are adjustment means, a given output means corresponding to a specific article and test.

The present invention also provides a method implementing in particular the above-described device.

Thus, the invention provides a method of controlling a test bench using a device for monitoring and controlling a test bench, the device being provided with bench control means and an interface including display means and communication means, the control means being suitable for controlling a test bench. The method is remarkable in that the following steps are performed in succession:

a) an operator uses the communication means to determine the type of test to be implemented from a first list of tests, the control means activating selector means to present the first list on the display means, insofar as the selector means possesses the first list;

b) an operator uses the communication means to determine the article for testing from a second list, the control means activating election means to present the second list on the display means, since the election means is in possession of the second list; and

c) the control means then instructs the test bench to perform the selected test on the article elected by the operator.

It should be observed that during step b), the election means depends on the test chosen during step a), the control means choosing the required election means as a function of the test selected by the operator. There are thus as many election means as there are possible tests.

To increase the safety of the method, prior to step a), the control means operate identification means to verify that the operator is entitled to perform the test. Identification can be implemented merely with a password or else by using techniques that are more complex, such as making use of finger, voice, or retina prints, for example.

Advantageously, prior to step c), the control means activate adjustment means informing it about the test conditions to be applied for implementing the selected test on the elected article, the control means then controlling the test bench during step c) in compliance with the conditions defined by the adjustment means.

The adjustment means then depend on the test chosen during step a) for the article elected during step b), with the control means choosing the required adjustment means as a function of the test and the article selected by the operator.

Furthermore, preferably during step d), acquisition means of the test bench send at least one measured test result to at least one acquisition input.

Thereafter, during an optional step e), the control means activate output means that format the presentation of the result so as to present it to the operator. The output means depend on the test chosen during step a) for the article elected during step b), with the control means choosing the required output means as a function of the test and the article selected by the operator.

In a variant involving the operator during the test, the output means formats said presentation in real time. The operator can then observe how test settings and/or monitored parameters vary, for example.

Advantageously, prior to step e), the control means activates calibration means that reset the result so as to compensate for deficiency of acquisition means of the bench.

Finally, in a variant of the invention, if step c) should be interrupted, then during a step c′) directly following step c), the control means ask the operator whether the test bench should be instructed to carry out the test again, optionally taking account of the portion of the chosen test that has already been implemented.

It is thus possible to stop the test bench temporarily in order to check some specific point, and then pick up the test, while conserving the results of cycles that have already been carried out, or else by starting again from the beginning. Similarly, it is possible to envisage restarting from some predetermined intermediate moment.

### BRIEF DESCRIPTION OF THE DRAWING

The invention and its advantages appear in greater detail from the following description that shows preferred embodiments given without any limiting character and that is given with reference to the sole accompanying FIGURE that is a block diagram of the architecture of the device of the invention.

The sole FIGURE presents a monitoring and control device 1 for a test bench 2.

The device has control means 3 that communicate with an operator via an interface 4 provided with display means, e.g. a screen, and communication means such as a keyboard or a computer mouse.

### MORE DETAILED DESCRIPTION

The operator then orders the control means 3 to put the test bench 2 into operation in order to perform a test.

The device is then provided with at least one acquisition input 3′ enabling an acquisition means of the bench to send test results 5 to the control means 3, which process them to display them on the display means 41 or on some other member, e.g. a printer suitable for printing a test report.

The device may have as many acquisition inputs 3′ as the test bench 2 has acquisition means and/or sensors.

The device is also provided with a set of means 6 used by the control means 3 for monitoring the bench 2, and possibly also for processing and displaying test result 5.

Specifically, the control means comprise a microprocessor programmed to be capable of controlling the test bench 2 and of using the information in the set of means 6. The control means and the set of means are thus distinct and do not form portions of the same software, unlike the above-described prior art.

The means of the set of means 6 are thus databases containing a variety of information, the set of means 6 thus being constituted by one or more computer memories.

To perform a specific test on a given bench for a specific purpose, the operator makes use of information from the set 6 of means.

In order to take advantage of modern technologies, the set of means could be located in a remote unit distinct from the unit provided with the control means, e.g. a server of a computer network. Each test bench would then be controlled by a device having its own control means 3, with each bench control means 3 then calling on the set of means arranged on one or more memories of said server.

Thus, when the set of means 6 is updated that would apply to all of the benches.

Nevertheless, by way of security, it appears preferable for each test bench control device to be fitted with its own set 6 of means, the set of means and the control means being arranged on a single unit.

Consequently, all of the test benches in a given undertaking are controlled by equivalent control means, these control means implementing identical sets 6 of means. As a result, all of the test benches operate on identical principles.

The device 1, and more particularly its set of means 6, then includes selector means 7, a database containing specifically a first list of tests that can be performed. The control means 3 then uses the selector means 7 to display the first list on the display means 41.

Thereafter, during a step a) of the method of the invention, the operator uses the communication means 42 for selecting the test that is to be performed by the bench 2.

The selector 7 means includes a correspondence table indicating which election means 9, 9′, 9″ correspond to the chosen test, with the number of election means being equal to the number of possible tests.

The display 1, and more particularly its set 6, is provided with a plurality of election means 9, 9′, 9″, where each election means is a database containing in particular a second list of articles that can be subjected to the previously-chosen test. The control means 3 make use of the election means corresponding to the chosen test for the purpose of displaying the second list on the display means 41. During a step b) of the method, the operator thus uses the communications means 42 to select the elected article that is to be subjected to the selected test on the bench 2.

Finally, during a step c) of the method, the control means 3 orders the bench 2 to begin the chosen test for the elected article.

Optionally, the set 6 of the device 1 includes identification means 8. Prior to step a), the control means 3 activate the identification means 8 in order to verify that the operator is indeed entitled to supervise said test.

With reference to the sole FIGURE, the set 6 of means is provided with auxiliary means, namely adjustment means 91, 91′, 91″, 911′, 911′, 911″, and output means 92, 92′, 92″, 922, 922′, 922″. For a given test, there are thus as many adjustment means and also output means as there are kinds of equipment capable of being subjected to said test.

For the example in the sole FIGURE, there are thus three possible tests, and two articles can each be subjected to tests, thus implying six adjustment means and six display means.

Prior to step c), the control means 3 implement the adjustment means corresponding to the chosen test and to the elected article. It determines which adjustment means are appropriate by using the information contained in the election means that possess a correspondence table between articles to be tested and the associated adjustment means.

The adjustment means 91, 91′, 91″, 911, 911′, 911″ are databases, e.g. providing all of the information relating to the test configuration, and for example:
the detailed steps of the test;
the values for test settings such as bench temperature or vibration level; and
the parameters that are monitored and valid values therefor.

With the help of this information, the control means 3 can monitor the bench 2 with accuracy, while following the specified steps, for example.

During a step d), the acquisition means (not shown in the sole FIGURE) of the test bench 2 send at least one test result, i.e. the value of a parameter that is being monitored during the test, to the control means 3 via an acquisition input 3′.

During a step e) the control means 3 operate the display means corresponding to the chosen test and to the elected article. It determines which output means are required with the help of information contained by the election means that possess a correspondence table between articles for testing and the associated output means.

The output means 92, 92′, 92″, 922, 922′, 922″ are databases, e.g. delivering information relating to how the measured result should be formatted. This result can then be output, possibly in real time, on the display means in the form of a data table or a curve, for example. It may also be printed in a test report of layout that is managed by the output means.

In a variant of the invention, the device 1 is provided with calibration means. The sensors of the bench 2 may deteriorate over time, and, for example, a value of 0° C. as measured by a temperature sensor may in fact correspond to 1° C. The calibration means then recalculate the results in order to take such deviations into consideration. The control means 3 implement the calibration means firstly so that the operator specifies the result to be reset and the value to which it should be reset, and secondly so as to recalculate the result during the test.

Naturally, the present invention can be subjected to numerous variants as to its implementation. Although several variants of the invention are described above, it will readily be understood that it is not conceivable to identify exhaustively all possible variants. It is naturally possible to envisage replacing means described by equivalent means without going beyond the ambit of the present invention.

What is claimed is:

1. A device (1) for monitoring and controlling a test bench (2) provided with control means (3) for controlling said bench (2) and with an interface (4) comprising display means (41) and communications means (42), said control means (3) being suitable for controlling said test bench (2), the device (1) being provided with a set (6) of means and at least one acquisition input (3′) for acquiring at least one test result measured by at least one acquisition means of said test bench (2), said set (6) of means comprising:
selector means (7) operated by said control means (3) to enable an operator to choose the type of test to be implemented; and
at least one election means (9, 9′, 9″) operated by said control means (3) in order to enable an operator to choose the article for testing.

2. A device according to claim 1, wherein said set (6) of means includes identification means (8) operated by said control means (3) to verify whether the operator is entitled to perform said test.

3. A device according to claim 1, wherein said set (6) of means comprises at least one adjustment means (91, 91′, 91″, 911, 911′, 911″) operated by said control means (3) to define test conditions, any one adjustment means (91, 91′, 91″, 911, 911′, 911″) corresponding to one specific article and one test.

4. A device according to claim 1, wherein said set (6) of means includes calibration means, operated by said control means (3) for resetting said result.

5. A device according to claim 1, wherein said set (6) of means includes at least one output means (92, 92′, 92″, 922, 922′, 922″) operated by said control means (3) to format the presentation of said result.

6. A device according to claim 5, wherein said output means (92, 92′, 92″, 922, 922′, 922″) formats said presentation in real time during said test, one output means (92, 92′, 92″, 922, 922′, 922″) corresponding to one specific article and one test.

7. A device according to claim 1, wherein said set (6) of means and said control means (3) are arranged on a common unit.

8. A device according to claim 1, wherein said set (6) of means is arranged on a distinct unit remote from the unit provided with said control means (3).

9. A method of controlling a test bench (2) with the help of a test bench monitoring and control device (1) provided with control means (3) for controlling said bench (2) and with an interface (4) including display means (41) and communication means (42), said control means (3) being suitable for controlling said test bench (2), the method being characterized by performing the following steps in succession:
a) an operator uses said communication means (42) to determine the type of test to be implemented from a first list, said control means (3) activating selector means (7) to present said first list on said display means (41), said selector means (7) being in possession of said first list;
b) an operator uses said communication means (42) to determine the articles to be tested from a second list, said control means (3) activating election means (9, 9′, 9″) for presenting said second list on said display means (41), said election means (9, 9′, 9″) being in possession of said second list; and
c) the control means instructs said test bench to perform the selected test on the elected article.

10. A method according to claim 9, wherein, during step b), said election means (9, 9′, 9″) depends on the test chosen during step a), said control means (3) selecting the required election means (9, 9′, 9″) as a function of the test selected by the operator.

11. A method according to claim 9, wherein, prior to step a), said control means (3) operate identification means (8) to verify whether said operator is entitled to perform said test.

12. A method according to claim 9, wherein, prior to step c), said control means (3) activate adjustment means (91, 91′, 91″, 911, 911′, 911″) that provide information about the test conditions for implementing the chosen test on the elected article, the control means (3) then controlling said bench (2) during step c) in accordance with the conditions defined by said adjustment means (91, 91′, 91″, 911, 911′, 911″).

13. A method according to claim 12, wherein prior to step c), said adjustment means (91, 91′, 91″, 911, 911′, 911″) depend on the test chosen during step a) for the article elected during step b), said control means (3) choosing the required adjustment means as a function of the test and of the article selected by the operator.

14. A method according to claim 9, wherein during step d), acquisition means of said test bench (2) send at least one measured test result to at least one acquisition input (3′).

15. A method according to claim 14, wherein during a step e), the control means (3) activate output means (92, 92′, 92″, 922, 922′, 922″) that format the presentation of said result in order to present it to the operator.

16. A method according to claim 14, wherein during step e), said output means (92, 92′, 92″, 922, 922′, 922″) depend on the test chosen during step a) for the article elected during step b), said control means (3) choosing the required output means (92, 92′, 92″, 922, 922′, 922″) as a function of the test and of the article selected by the operator.

17. A method according to claim 15, wherein said output means (92, 92′, 92″, 922, 922′, 922″) format the presentation in real time during said test.

18. A method according to claim 14, wherein, prior to step e), said control means (3) activate calibration means that reset said result.

19. A method according to claim 9, wherein, if step c) is interrupted, then during a step c′) immediately following step c), the control means (3) asks the operator whether said bench should be instructed to restart said test, optionally taking account of the portion of the chosen test that has already been implemented.
